(19) United States
(12) Patent Application Publication
(10) Pub. No.: US 2005/0286373 A1
(43) Pub. Date: Dec. 29, 2005

(54) Information processing device, disc unit, information processing method, information processing program and recording medium containing the program

(75) Inventor: Takaaki Ujiie, Kawagoe-shi (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: PIONEER CORPORATION, Tokyo, Japan

(21) Appl. No.: 11/092,972

(22) Filed: Mar. 30, 2005

(30) Foreign Application Priority Data
Mar. 30, 2004 (JP) 2004-099475

(51) Int. Cl. G11B 7/00

(52) U.S. Cl. 369/53.1; 369/47.1; 369/44.27

(57) ABSTRACT

The number of subcodes n1 and n2 at different positions in the radial direction of an optical disc 10 which is rotated under the constant linear velocity control and distances r1 and r2 between the positions and the center of the optical disc 10 are recognized. Based on the number of subcodes, distances, and the type of the optical disc 10, the specific linear velocity L is calculated using the following relational expression: L=((r1×r1−r2×r2)×π)/(Tp(n1−n2)/V). An actual predetermined position at which information processing is performed is calculated with relative ratio based on the specific linear velocity L. At the time when information processing is performed, it is possible to adequately move the optical pickup 220 to the actual information processing position, thereby reducing the time to start information processing and resulting in speedy information processing.

### BACKGROUND OF THE INVENTION

1. Field of the Invention

The present invention relates to an information processing device which performs at least one of a process of reading information recorded on the recording surface of a recording medium and a process of recording the information onto the recording surface, its method, its program, a recording medium containing the program, and a disc unit.

2. Description of Related Art

It has been desired to reduce the time required to start an information processing operation for a disc recording medium in a disc unit which reads information from a disc recording medium such as an optical disc or records information in the medium, and a configuration that reduces the time for setting-up is known (see, for example, Jpn. Pat. Laid-Open Publication No. 2001-332011).

The configuration disclosed in the above publication sets up a new disc according to the reproduction condition of CD-DA, and, when correct focus cannot be obtained, it changes the amplification factor of an OEIC and focus gain based on predetermined condition. Alternatively, it consecutively performs focus search with the reproduction condition of CD-DA as the reproduction condition of DVD7 and sets reproduction condition suitable for DVD reproduction at the time when correct focus is obtained. That is, a configuration in which the reproduction condition that has previously been set is used to perform a set-up operation in a consecutive manner in order to set up the reproduction condition of DVD has been adopted.

Here, assume that two CDs of the same type are reproduced in the case where correct focus can be obtained in both the CDs in a conventional configuration as described in the above publication. In this case, even when the same information has been recorded on the respective CDs, if the information has been recorded with different linear velocities, recorded positions of the information differ between the two. Accordingly, when an optical pickup is moved by the same distance in order to reproduce the same information, the desired information on one CD can be reproduced; whereas the same information on other CD cannot be read, and therefore the information is searched again and the optical pickup is moved to the position at which the desired information has been recorded. As described in the above example, it has been desired to reduce the time to start information processing such as reproduction.

### SUMMARY OF THE INVENTION

A main object of the present invention is to provide an information processing device capable of performing information processing satisfactorily, its method, its program, a recording medium containing the program, and a disc unit.

According to a first aspect of the present invention, there is provided an information processing device that allows a drive section to rotate a disc recording medium and allows an information processing section which is moved, by a moving section, along the recording surface of the disc recording medium in the radial direction thereof to perform at least one of a process of reading information recorded on the disc recording medium and a process of recording the information onto the disc recording medium, including: a drive control section that controls the rotation of the drive section to allow the information processing section to read at least one of the number of frames and the number of preformat information recorded at a plurality of positions different in the radial direction of the disc recording medium; a distance recognition section that recognizes the moving status of the information processing section and thereby recognizes the distances between the respective positions at which the information processing section reads the information and the center of the disc recording medium; and a movement distance control section that recognizes a predetermined position of the information to be processed on the disc recoding medium in response to a request for information processing, recognizes the distance between the predetermined position-on the disc recording medium and the center thereof based on the number of the information that has been read at the different positions, the recognized respective distances, and the type of the disc recording medium, and controls, based on the recognized distance, the moving section to move the information processing section to the predetermined position.

According to a second aspect of the present invention, there is provided an information processing device that allows a drive section to rotate a disc recording medium and allows an information processing section which is moved, by a moving section, along the recording surface of the disc recording medium in the radial direction thereof to perform at least one of a process of reading information recorded on the disc recording medium and a process of recording the information onto the disc recording medium, including: a drive control section that controls the rotation of the drive section to allow the information processing section to read at least one of the number of frames and the number of preformat information recorded at a plurality of positions different in the radial direction of the disc recording medium; a distance recognition section that recognizes the moving status of the information processing section and thereby recognizes the distances between the respective positions at which the information processing section reads the information and the center of the disc recording medium; and a movement distance control section that calculates the linear velocity of the disc recording medium based on the number of the information that has been read at the different positions, the recognized respective distances, and the type of the disc recording medium, calculates the distance between a predetermined position of the information to be processed on the disc recoding medium and the center thereof based on the linear velocity, and controls, based on the calculated distance, the moving section to move the information processing section to the predetermined position.

According to a third aspect of the present invention, there is provided a disc unit including: a drive section that rotates a disc recording medium; an information processing section that performs at least one of a process of reading information recorded on the disc recording medium and a process of recording the information onto the disc recording medium; a moving section that moves the information processing section along the recording surface of the disc recording medium in the radial direction thereof; and the abovementioned information processing device according to the present invention.

According to a fourth aspect of the present invention, there is provided a disc unit including: an information processing section that performs at least one of a process of reading information recorded on a disc recording medium and a process of recording the information onto the disc recording medium; a moving section that moves the information processing section to move along the recording surface of the disc recording medium in the radial direction thereof, a controller that calculates the distance between a predetermined position of the information to be processed on the disc recording medium and the center of the disc recording medium based on at least one of the number of frames and the number of preformat information recorded at different positions on the disc recording medium in the radial direction and read by the information processing section, the distances up to the respective positions at which the information processing sections reads the information, and the type of the disc recording medium to allow the moving section to move the information processing section.

According to a fifth aspect of the present invention, there is provided an information processing method that rotates a disc recording medium and moves the information processing section along the recording surface of the disc recording medium in the radial direction thereof to thereby perform at least one of a process of reading information recorded on the disc recording medium and a process of recording the information onto the disc recording medium, including the steps of: counting at least one of the number of frames and the number of preformat information recorded at different positions on the disc recording medium in the radial direction and recognizing the distance between the respective positions and the center of the disc recording medium; recognizing a predetermined position of the information to be processed on the disc recoding medium in response to a request for information processing to thereby recognize the distance between the predetermined position on the disc recording medium and the center thereof based on the number of the information that has been read at the different positions, the recognized respective distances, and the type of the disc recording medium; and controlling the moving section based on the recognized distance to move the information processing section to the predetermined position.

According to a sixth aspect of the present invention, there is provided an information processing method that rotates a disc recording medium and moves the information processing section along the recording surface of the disc recording medium in the radial direction thereof to thereby perform at least one of a process of reading information recorded on the disc recording medium and a process of recording the information onto the disc recording medium, including the steps of: counting at least one of the number of frames and the number of preformat information recorded at different positions on the disc recording medium in the radial direction and recognizing the distance between the respective positions and the center of the disc recording medium; calculating the linear velocity of the disc recording medium based on the number of the information that has been read at the different positions, the recognized respective distances, and the type of the disc recording medium; calculating the distance between a predetermined position of the information to be processed on the disc recoding medium and the center thereof based on the calculated linear velocity; and controlling the moving section based on the calculated distance to move the information processing section to the predetermined position.

According to a seventh aspect of the present invention, there is provided a recording medium on which an information processing program is recorded in a readable manner by a calculation section, the information processing program allowing the calculation section to function as an information processing device.

### BRIEF DESCRIPTION OF THE DRAWINGS

FIG. 1 is a block diagram schematically showing the configuration of a disc unit according to an embodiment of the present invention;

FIG. 2 is a partly cutaway plan view showing the vicinity of a disc processing section in the embodiment;

FIG. 3 is a block diagram schematically showing the configuration of a system controller in the embodiment;

FIG. 4 is an explanatory view to help explain the moving state of an optical pickup in the embodiment; and

FIG. 5 is an illustration explaining how a linear velocity is measured in the embodiment.

### DETAILED DESCRIPTION OF PREFERRED EMBODIMENTS

An embodiment of the present invention will be described below with reference to the accompanying drawings.

Though in the embodiment, a disc unit that records and reads information on/from an optical disc which is a detachable disc recording medium is taken as an example, the disc unit may perform only one of the information reading and recording operations. Also, the disc recording medium is not limited to the optical disc, but can be any disc recording medium such as a magnetic disc, a magneto optical disc. The disc unit is not limited to a disc unit for use in a car-mounted reproduction apparatus, but any configuration including, for example, one called “Slim Drive” in which an optical pickup is provided integrally with a tray to be fitted to an electrical apparatus such as a portable personal computer, one having a tray that conveys an optical disc, one called “Slot in Type” in which a conveyance tray is not provided, or the like can be employed. Further, a stand-alone disc unit such as a game machine or reproduction apparatus that records or reproduces video data and like can be employed.

[Configuration of Disc Unit]

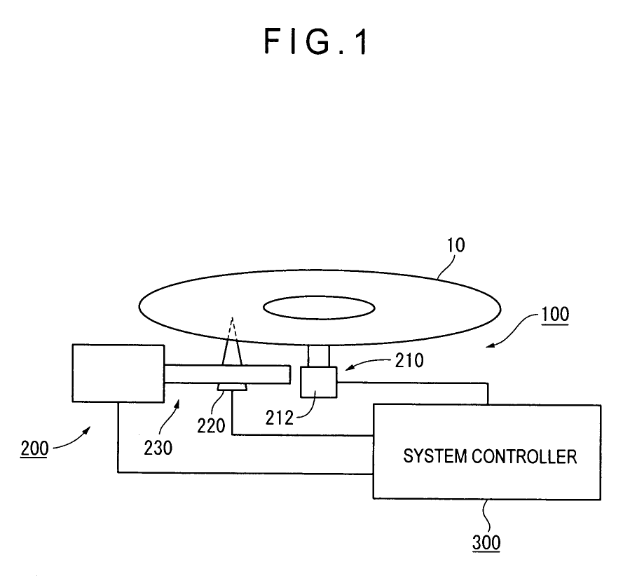

In FIG. 1, a disc unit 100 is, for example, a car-mounted reproduction unit. The disc unit 100 performs a reading process which is information processing of reading out information recorded on a recording surface (not shown) formed at least on one surface of a disc-shaped optical disc 10 serving as a disc recording medium detachably attached to the disc unit 100 and a recording process which is another information processing of recording various information onto the recording surface. The disc unit 100 has substantially a box-shaped hollow case body (not shown) made of metal, and an opening portion which opens in a slit is formed on the front surface of the case body. Provided within the case body are a disc processing section 200 which performs the information processing, a conveyance section (not shown), and a system controller 300 which is an information processing unit serving both as a calculation section and controller to control the entire operation of the disc unit 100.

The disc processing section 200 includes a drive section 210 for rotating the optical disc 10, an optical pickup 220 serving as an information processing section, and a moving section 230 for moving the optical pickup 220 along the recording surface of the optical disc 10 in the radial direction thereof. Under the control of the system controller 300, the disc processing section 200 rotates the optical disc 10 with a constant linear velocity by the drive section 210 and appropriately moves the optical pickup 220 along the recording surface of the rotating optical disc 10 by the moving section 230, to thereby allow the optical pickup 220 to read out information recorded on the recording surface and to record information onto the recording surface.

The conveyance section conveys the optical disc 10 to the inside or outside of the case body through the opening portion. The conveyance section is connected to the system controller 300. When detecting that a part of the optical disc 10 is inserted into the opening portion, the system controller 300 allows the conveyance section to rotate a roller (not shown) or the like to convey the optical disc 10 toward the inside of the case body, up to the position where the disc processing section 200 can apply predetermined processing thereto. Further, when recognizing a signal requesting the eject of the optical disc 10 that has been attached into the case body (for example, a signal issued by the operation of an eject button), the system controller 300 allows the conveyance section to rotate a roller (not shown) or the like to convey the optical disc 10 that has been held in the position where the predetermined processing can be applied to the optical disc 10 by the disc processing section 200 to the outside of the case body through the opening portion.

(Configuration of Disc Processing Section)

A detailed configuration of the disc processing section 200 will next be described with reference to the accompanying drawings.

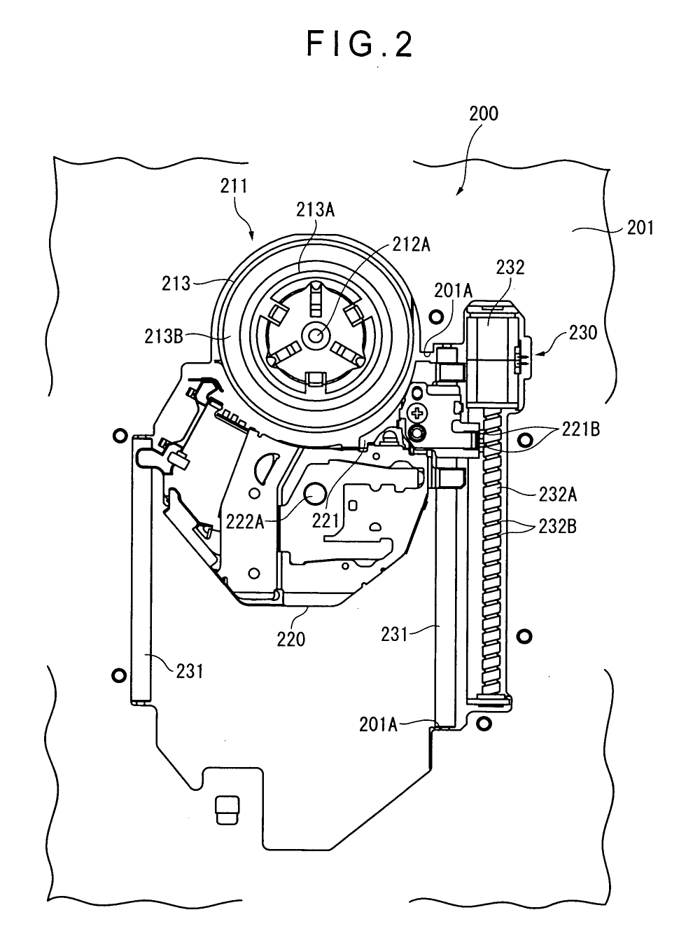

The disc processing section 200 has a pair of base portions (not shown) facing each other. The base portions are so provided in the case body as to be rotatable in the directions opposed to each other. Provided on the one base portion is a disc rotation drive section 211 constituting the drive section 210 together with a rotor (not shown) which is rotatably supported on the other base portion. The disc rotation drive section 210 includes a spindle motor 212 (shown in FIG. 1) provided on one base portion 201, and a turntable 213 (shown in FIG. 2) integrally provided with an output shaft 212A of the spindle motor 212. The spindle motor 212 is so connected to the system controller 300 as to be controllable by the controller 300 and driven by an electrical power supplied from the system controller 300. The turntable 213 includes substantially a column-shaped rotating shaft 213A serving as a shaft support portion which is inserted for fitting into a shaft hole (not shown) formed in the center of the optical disc 10 to rotatably support the optical disc 10 and a flange portion 213B which is projected from the outer circumferential surface around the rotating shaft 213A and on which the periphery of the shaft hole of the optical disc 10 is placed to support the optical disc 10. The rotation of the base portions in the opposite directions to each other allows the optical disc 10 to be held between the turntable 213 and a rotor (not shown) supported on the base portion different from that the turntable 213 is provided on. The optical disc 10 thus held is rotated together with the turntable 213 and rotor which are rotated by the drive of the spindle motor 212.

Further, provided on the base portion 201 is the moving section 230 which moves the optical pickup 220. The moving section 230 includes a pair of guide shafts 231 and a stepping motor 232. The pair of guide shafts 231 are, for example, elongated metal bars and arranged in substantially parallel to each other on the base portion 201. The stepping motor 232 is so connected to the system controller as to be controllable by the controller and driven by an electrical power supplied from the system controller. A lead screw 232A, which is, for example, an elongated metal bar, is concentrically and integrally connected to the output shaft (not shown) of the stepping motor 232. An engagement groove 232B is formed in a spiral manner on the outer circumferential surface of the lead screw 232A.

The optical pickup 220 is movably supported by the pair of guide shafts 231. The optical pickup 220 includes a holder 221 which is held between the pair of guide shafts 231 in a bridged manner. A movement regulating claw 221B to be engaged with the engagement groove 232B of the lead screw 232A of the moving section 230 is formed in the holder 221. The optical pickup 220 includes, in the holder 221, a light source (not shown), a plurality of optical elements (not shown) having an objective lens 222A which allows a light from the light source to irradiate on the optical disc, an optical sensor (not shown) which detects the light reflected by the optical disc 10, and the like. The optical pickup 220 is connected to the system controller 300, so that a signal can be exchanged between the two. Under the control of the system controller 300, the optical pickup 220 performs a process of reading various information recorded on the recording surface of the optical disc 10 so as to output the read information to the system controller 300 as well as a process of recording various information from the system controller 300 onto the recording surface.

(Configuration of System Controller)

A detailed configuration of the system controller will next be described with reference to the accompanying drawings.

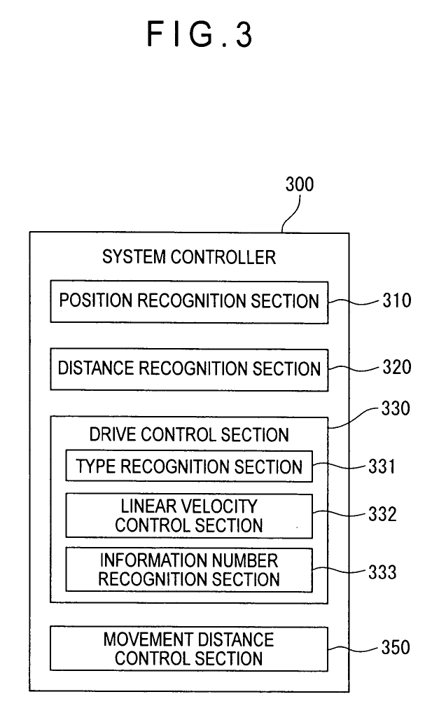

The system controller 300 is, as a circuit configuration, arranged on a circuit board which mounts various electrical components, for example. The system controller 300 includes, as shown in FIG. 3, programs such as a position recognition section 310, a distance recognition section 320 also serving as a distance calculation section, a drive control section 330, a movement distance control section 350, and an internal counter (not shown).

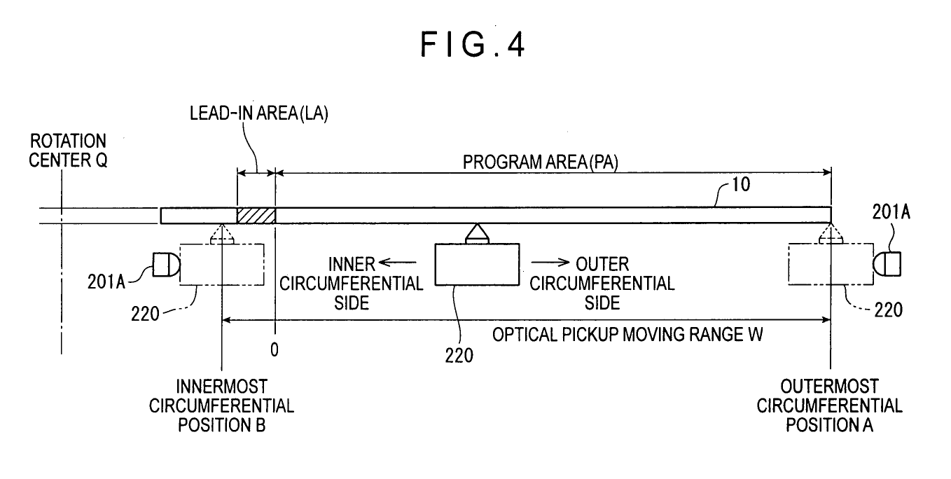

The position recognition section 310 recognizes the position of the optical pickup 220. The position recognition section 310 recognizes the position of the optical pickup 220 based on the count value of the not-shown internal counter. The position recognition section 310 also performs initialization processing to appropriately drive the stepping motor 232 serving as the moving section 230. The initialization processing is performed by causing a so-called loss of synchronism. In the initialization processing, as shown in FIG. 4, drive pulses of the same or slightly more than the pulse number required to move the optical pickup 220 over the entire movable range W between one-end sides and the other-end sides of the pair of guide shafts 231 are supplied to the stepping motor 232 to drive the same. When the drive pulses are thus supplied, the optical pickup 220 is moved to, for example, an innermost circumferential position B corresponding to the innermost circumference of the optical disc 10 to come into contact with the movement regulator 201A of the base portion 201. In the contact state, since the supply of the drive pulses to the lead screw 232A continues, and that results in a state of so-called loss of synchronism where the lead screw 232A can no longer be rotated. Thereafter, the position recognition section 310 sets the count value of the not-shown internal counter to that indicating the innermost circumferential position B. The value of the internal counter is represented by, for example, integral values. The initialization of the count value of the internal counter makes the position of the optical pickup 220 corresponding to the count value of the internal counter. As a result, the position recognition section 310 can recognize the position of the optical pickup 220 based on the count value of the internal counter.

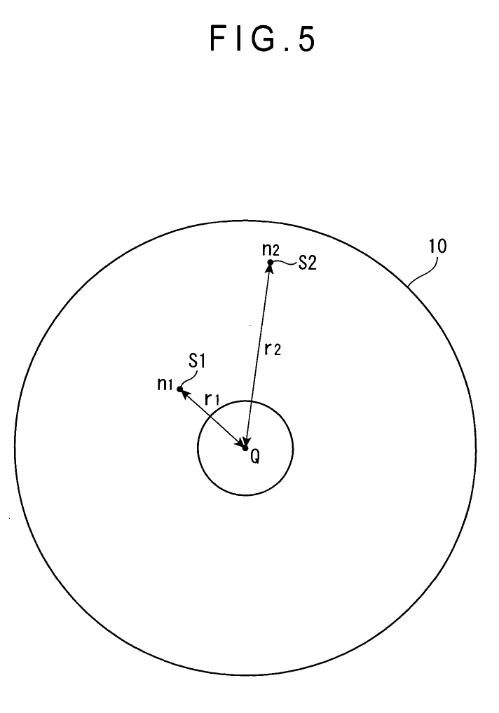

The distance recognition section 320 recognizes a state where the optical pickup 220 is moved by the moving section 230 to recognize the distance between the center Q of the optical disc 10 and the position at which the optical pickup 220 reads information. More specifically, the distance recognition section 320 recognizes the position of the optical pickup 220 based on the count value of the internal counter of the position recognition section 310. Based on the recognized position, the distance recognition section 320 recognizes the distance between the center Q of the optical disc 10 and the position on the recording surface of the optical disc 10 at which a light from the optical pickup 220 is focused, as exemplified by distances r1 and r2 [m] in FIG. 5.

The drive control section 330 controls the drive state of the spindle motor 212. In this control of the drive state, the drive control section 330 controls the rotation of the optical disc 10 so that the linear velocity of the optical disc 10 is constant, that is, the rotation speed of the optical disc 10 is constant at any position where the optical pickup 220 reads the information on the optical disc 10. The drive control section 330 includes a type recognition section 331, a linear velocity control section 332 serving as a rotation speed control section and an information number recognition section 333.

The type recognition section 331 of the drive control section 330 recognizes the type of the optical disc 10. When, for example, the optical disc 10 is attached, the type recognition section 331 of the drive control section 330 controls the optical pickup 220 to focus a light on the recording surface of the optical disc 10 and determines the type of the optical disc 10 based on the light receiving state of the reflected light. When determining that the optical disc 10 is not an appropriate type, the type recognition section 331 drives the conveyance section to eject the optical disc 10. On the other hand, when determining that the optical disc 10 is a predetermined appropriate type, the type recognition section 331 stores the type in, for example, a memory (not shown). The information related to the type of the optical disc 10 stored in the memory is deleted when the optical disc 10 is ejected. The type recognition section 331 is not limited to the above configuration and it may use any other method to recognize the type of the optical disc 10.

The linear velocity control section 332 of the drive control section 330 controls the rotation speed of the output shaft 212A of the spindle motor 212 based on the count value of the internal counter corresponding to the position of the optical pickup 220 that the position recognition section 310 has recognized so that the optical pickup 220 can read information at a plurality of positions different in the radial direction of the optical disc 10. In FIG. 5, for example, information such as a predetermined number of frames which is information number, the number of address information which is format information, or pit number at positions S1 and S2, more specifically, the number of subcodes n1 and n2 is allowed to be read by the optical pickup 220.

The information number recognition section 333 of the drive control section 330 counts the number of subcodes n1 and n2 which is information number at positions (for example, S1 and S2 as shown in FIG. 5) different in the radial direction of the optical disc 10. The counted value is stored in the memory.

The movement distance control section 350 recognizes the characteristics of the optical disc 10, that is, the specific linear velocity L of the optical disc 10 (for example, the linear velocity obtained at the time when music information or image information is recorded, or the linear velocity at the time when the disc is preformatted) based on the information numbers n1 and n2 counted by the information number recognition section 333 of the drive control section 330, respective distances r1 and r2 to the respective positions S1 and S2 recognized by the distance recognition section 320, and the type of the optical disc 10 recognized by the type recognition section 331 of the drive control section 330.

More specifically, the linear velocity L is calculated based on the following relational expressions:
L=((r1×r1−r2×r2)×π)/(K(n1−n2))
K=Tp/V
where
   L: specific linear velocity of optical disc 10,
   r1: distance to first position S1,
   r2: distance to second position S2,
   n1: number of subcodes read at first position S1,
   n2: number of subcodes read at second position S2,
   K: variable corresponding to type of optical disc 10,
   Tp: track pitch length of optical disc 10, and
   V: coefficient corresponding to type of optical disc 10.

When the above relational expressions are deformed, the above relational expression is obtained:
L×Tp=((r1×r1−r2×r2)×π)×V/(n1−n2)
Therefore, when values of r1, r2, n1, and n2 are obtained, the value of L×Tp can be calculated.

Further, the movement distance control section 350 calculates the distance between the position of the predetermined information recorded on the optical disc 10 and the center Q thereof using the values of L×Tp, r1, n1, n2 obtained by the above expressions from the following relational expression:
r2=(−(L×Tp×(n1−n2)/(V×π))+(r1×r1))^{1/2}
which is obtained by deforming the above relation expression:
L=((r1×r1−r2×r2)×n)/(Tp(n1−n2)/V).

The movement distance control section 350 moves the moving section 230 based on the calculated distance. That is, the movement distance control section 350 performs the control so that the count value of the internal counter becomes a predetermined value.

[Operation of Disc Unit]

An operation of the disc unit 100 in the first embodiment will next be described.

Upon supply of power to the electrical apparatus, power is applied to the disc unit 100. The system controller 300, which starts operating by receiving the power, performs the initialization processing (normalization of the optical pickup 220) to recognize the position of the optical pickup 220. That is, the position recognition section 310 of the system controller 300 allows drive pulses of the same or slightly more than the pulse number required to move the optical pickup 220 toward the innermost circumferential position B within the entire movable range W to be supplied to the stepping motor 232 of the moving section 230. As a result, a loss of synchronism of the stepping motor 232 occurs. In this state, the position recognition section 310 sets the count value of the internal counter to that indicating the innermost circumferential position B.

Thereafter, the system controller 300 determines whether the optical disc 10 has been attached or not. The system controller 300 determines the presence/absence of the optical disc 10 through the detection operation of the optical disc 10 using a disc detection section such as separately provided not-shown sensor or switch or the detection operation of the optical disc 10 in which the optical pickup 220 is controlled to detect the presence/absence of the emitted light reflected by the optical disc 10. When determining that the optical disc 10 has not been attached, the system controller 300 continues waiting for the attachment of the optical disc 10. On the other hand, when determining that the optical disc 10 has been attached, the system controller 300 allows the optical pickup 220 to read out information in a lead-in area of the attached optical disc 10 to recognize recording state or recoding contents and allows a display unit (not shown) provided in the disc unit 100 to appropriately display the recording state or recoding contents.

When determining the presence/absence of the optical disc 10 based on the light receiving state of the emitted light reflected by the optical disc 10 obtained as a result of focus search performed by the optical pickup 220, the system controller 300 allows the type recognition section 331 of the drive control section 330 to recognize the type of the optical disc 10, and then allows the information number recognition section 333 of the drive control section 330 to count the number of subcodes n1 (n2) at the position S1 (S2) where the optical pickup 220 reads information. Further, the system controller 300 allows the distance recognition section 320 to recognize the distance r1 (r2) between the position S1 (S2) and the center Q of the optical disc 10. The system controller 300 then determines that the optical disc 10 has been attached and, at the same time, recognizes the type of the optical disc 10 and stores it in the memory.

When the system controller 300 detects that the optical disc 10 has been attached in its waiting state for the attachment of the optical disc 10, that is, when a not-shown sensor or detection switch has detected that a part of the optical disc 10 has been inserted into the opening portion, the system controller 300 allows the conveyance section to start operating. For example, the conveyance section rotates a not-shown roller to convey the optical disc 10 toward the inside of the case body, up to the position where the disc processing section 200 can apply predetermined processing thereto. When the optical disc 10 is conveyed to the predetermined position, the pair of base portions 201 are rotated in the opposite directions to each other to clamp the optical disc 10, that is, to hold the optical disc between the turntable 213 and rotor. As a result, the system controller 300 recognizes the attachment of the optical disc 10. Thereafter, as described above, the system controller 300 recognize the type of the optical disc 10 by the type recognition section 331 and, at the same time, recognizes the distance r1 (r2) to the position S1 (S2) and information number n1 (n2) at the position S1 (S2) and stores the above information in the memory.

After recognizing the distance r1 (r2) and information number n1 (n2), the system controller 300 controls the operation of the moving section to allow the optical pickup 220 to read out information in lead-in area of the optical disc 10. The system controller 300 then recognizes recording state or recording contents based on the read out information and appropriately displays it. When a user performs an input operation through a not-shown operating section provided in the disc unit 100 with reference to the displayed contents, the system controller 300 recognizes a signal corresponding to the user's input operation and allows the disc processing section 200 to operate to thereby appropriately perform information processing to read out the recorded information from the optical disc 10 or record information onto the optical disc 10. During the information processing, the system controller 300 controls the operation of the disc processing section 200 with the assumption that the specific linear velocity L of the optical disc 10 is, for example, 1.3 [m/s] which is a standard linear velocity. When the specific linear velocity L corresponds to the assumed value, the optical pickup 220 is moved to a desired position based on the information in the lead-in area and the information processing is performed as required. On the other hand, when the specific linear velocity L differs from the assumed value, the optical pickup 220 is moved to a position different from the predetermined position. In this case, the system controller 300 controls the operation of the disc processing section 200 to move the optical pickup 220 to the desired position and to perform the information processing as required.

During the information processing, the system controller 300 also performs processing of recognizing the distance r2 (r1) to the position S2 (S1) and information number n2 (n1) at the position S2 (S1) in the same manner as described above. When the system controller 300 recognizes the distances r1 and r2 to the position S1 and S2 and information numbers n1 and n2 at the different positions S1 and S2, it allows the movement distance control section 350 to recognize the specific linear velocity L of the optical disc 10 based on the abovementioned relational expression and stores above information in the memory as required.

Thereafter, when the system controller 300 recognizes a request to perform information processing at another position, it allows the movement distance control section 350 to calculate the distance between the position at which the information processing is performed and the center Q based on the specific linear velocity L. That is, the movement distance control section 350 recognizes the position at which the information processing is performed based on the contents information described in the lead-in area that it has already recognized and calculates the distance based on the linear velocity L.

More specifically, the recognized and stored values are used to calculate the distance based on the following relational expression obtained by deforming the above relational expression of the linear velocity L:
r2=(−(L×K×(n1−n2)/π)+(r1×r1))^{1/2}

The system controller 300 then controls the drive of the moving section 230 based on the calculated distance r2, that is, allows the moving section 230 to supply the stepping motor 232 with drive pulses so that the count value of the internal counter indicates the position corresponding to the calculated distance to move the optical pickup 220. As a result, the optical pickup 220 is adequately moved to a target position based on the specific linear velocity L of the optical disc 10.

[Effect of Disc Unit]

As described above, in the above embodiment, the information number recognition section 333 of the drive control section 330 counts the information number of subcodes n1 and n2 recorded in the different positions S1 and S2 in the radial direction of the optical disc 10 and the distance recognition section 320 recognizes the distances r1 and r2 between the positions S1, S2 and the center Q of the optical disc 10. After that, the movement distance control section 350 calculates the specific linear velocity L of the optical disc 10 based on the information numbers n1 and n2, distances r1 and r2, and the type of the optical disc 10. A predetermined position at which information processing is performed based on a request for information processing is recognized using contents information and so on, and the distance between the actual predetermined position and the center Q is calculated based on the calculated linear velocity L. That is, the actual predetermined position at which information processing is performed is calculated based on the linear velocity L with relative ratio. The drive of the moving section 230 is then controlled based on the calculated distance to move the optical pickup 220 to the predetermined position at which information processing is performed. As a result, at the time when information processing is performed, the optical pickup 220 can be moved to an adequate position with simple calculations based on the specific linear velocity L of the optical disc 10, thereby reducing the time to start information processing and resulting in speedy information processing. Further, at the time when the presence/absence, type, or the like of the optical disc 10 is determined, the processing for recognizing the specific linear velocity L of the optical disc 10 need not be separately performed but can be performed in parallel with the other processing, thereby reducing the time to start information processing. As a result, speedy information processing can be achieved and usability can be increased.

The specific linear velocity L is recognized based on the information numbers n1, n2 at the different positions S1 and S2 and distances r1, r2 to the different positions S1 and S2 and the distance between a predetermined position of the information to be processed and the center Q is calculated based on the linear velocity L with relative ratio. Therefore, with simple calculations, it is possible to easily and adequately recognize a predetermined position of the information to be processed, thereby adequately realizing speedy information processing.

Assuming that the specific linear velocity of the optical disc 10 is L, the distance to the first position S1 is r1, the distance to the second position S2 is r2, the number of subcodes read at the first position S1 is n1, the number of subcodes read at the second position S2 is n2, the track pitch length of optical disc 10 is Tp, and the coefficient corresponding to type of optical disc is V, the following relational expression is obtained.
L=((r1×r1−r2×r2)×π)/(Tp(n1−n2)/V)

Based on the above relational expression, the distance between a predetermined position and the center Q of the optical disc 10 is calculated with relative ratio. Therefore, it is possible to easily recognize the information density of the optical disc 10 and thereby to easily and adequately recognize a predetermined position at which information processing is actually performed with relative ratio based on simple calculations.

The stepping motor 232 is used as the moving section 230 for moving the optical pickup 220 to control the movement of the optical pickup 220 by the count value of the internal counter. Therefore, it is possible to accurately recognize the position of the optical pickup 220 and distances r1 and r2 to the respective positions S1 and S2, making it easy to more adequately recognize a predetermined position.

The count of the information numbers n1 and n2 makes it easy to recognize the specific linear velocity L of the optical disc 10 used for performing speedy and adequate information processing.

Further, the type of the optical disc 10 is determined based on the light receiving state of the emitted light reflected by the optical disc 10 obtained as a result of focus search performed by the optical pickup 220. Therefore, at the time when the type of the optical disc 10 is recognized, the distance r1 (r2) to the position S1 (S2) can easily be recognized, making it easy to realize speedy information processing.

Further, when the attachment of the optical disc 10 is recognized, the distance r1 (r2) to the position S1 (S2) and information number n1 (n2) at the position S1 (S2) are recognized in order to obtain the specific linear velocity L of the optical disc 10. That is, when the optical disc 10 has been attached, the processing for recognizing the specific linear velocity L of the optical disc 10 is performed while the optical pickup 220 is operated in order to determine the presence/absence and type of the optical disc 10. Therefore, after attachment of the optical disc 10, it is possible to recognize the distance r1 (r2) and information amount n1 (n2) on at least one of the positions S1 (S2) before the information processing, making it easy to realize speedy information processing.

The above configuration is applied to the disc unit 100 to which the optical disc 10 is detachably attached. Therefore, when a different type of the optical disc 10 has been attached, the optical pickup 220 can quickly and adequately be moved depending on the specific linear velocity L of the attached optical disc 10 to a predetermined position at which information processing is performed. In particular, it is advantageous that the distances r1, r2, and information amount n1, n2 can be obtained when the different type of the optical disc 10 has been attached.

Further, the system controller 300 including various programs is adopted as a circuit configuration. Therefore, it is easily possible to obtain the above-mentioned configuration simply by loading programs, thereby increasing manufacturability. Further, it is possible to load the programs into the conventional disc unit to obtain the configuration according to the present invention, easily increasing versatility.

[Modification]

The present invention is not limited to the above embodiment but can be modified without departing from the scope of the invention as follows.

In the above embodiment, the disc unit 100 uses the disc recording medium. As described above, the disc unit 100 can use any disc recording medium including a magnetic disc, a magneto optical disc, and the like, in addition to the optical disc 10. Further, the present invention can be applied to the disc unit 100 that performs only one of reading and recording processes. Further, any configuration including so-called a Slim Drive, Slot in Type, tray type having a tray, and the like can be employed as the disc unit 100. The configuration of the information processing section is not limited to the pick-up mechanism for the disc recording medium, that is, a mechanism using a light, but any configuration such as a magnetic head can be used.

As the moving section 230 that moves the optical pickup 220, any motor such as a DC motor can be used in addition to the stepping motor 232. Further, any configuration such as one in which the optical pickup 220 is moved along with the rotation of an endless belt or one utilizes a linear motor can be used.

As the initialization processing, which is a normalization method for recognizing the position of the optical pickup 220, the configuration allowing so-called the loss of synchronism to occur is used. Alternatively, however, any method can be used for detecting the position of the optical pickup 220. For example, a method that uses a sensor or switch to detect that the optical pickup 220 has been set to the innermost circumferential position B, stops the optical pickup 220 at that position bead on specific address information, and recognizes the position of the optical pickup 220 with the stop position as a reference can be adopted.

The distances r1 and r2 to the different positions S1 and S2 and information numbers n1 and n2 at the different positions S1 and S2 are recognized in the above embodiment. Alternatively, however, distances and information numbers on three or more positions may be recognized. In the case where values on a plurality of positions are used, a method can be used in which the linear velocity L is calculated based on the detected distances and information numbers, and the specific linear velocity L is then obtained by calculation of average value or standard deviation.

Although each of the components included in the system controller 300, such as position recognition section 310, distance recognition section 320 also serving as the distance calculation section, drive control section 330, movement distance control section 350, and not-shown internal counter is constituted as a program in the above embodiment, they may be configured as a circuit or circuit element. Further, the configuration of the system controller 300 is not limited to that including the above components. For example, a configuration is allowable in which a means for recognizing the specific linear velocity L of the optical disc 10 with any method based on distances to a plurality of any different positions and information numbers at a plurality of any different positions is provided, and a predetermined position at which information processing is performed is recognized based on the linear velocity L in a relative way. Further, the system controller 300 can be distributed as an information processing unit configured as a circuit board, a program allowing the abovementioned operations to be performed, or a recording medium that stores the program.

Although the specific linear velocity is recognized based on the position S1 at the time of attachment of the optical disc 10 and position S2 at the time of first information processing in the above embodiment, the distances and information numbers for recognizing the specific linear velocity L may be recognized at any timing. For example, the distances S1 and S2 may be set to the positions at the time of the attachment of the optical disc 10 and at the time of reading the information of lead-in area, respectively, or they may be set to the different positions S1 and S2 at which information processing are performed. Once the specific linear velocity is recognized, the optical pickup 220 can adequately be moved to a predetermined position as described above, so that it is preferable that the specific linear velocity L be calculated in the early stage. Further, any information may be counted in place of the subcodes, as long as it indicates the information density.

Although CD-DA is taken as a concrete example, a disc recording medium that can be used in the present invention is not limited to one previously stores contents and the like, but any recording medium including unused and rewritable one in which contents has not been recorded, one in which only preformat information has been recorded, one in which contents has been recorded partly, and the like can be used. Examples of such disc recording medium include DVD-R (Digital Versatile Disc Recordable), DVD-RW (Digital Versatile Disc Rewritable), CD-RAM (Compact Disc Random Access Memory) and the like. The linear velocity control should appropriately be performed based on the number of frames, the number of access information, and the number of pits corresponding to the type of the disc.

The concrete structure and procedure of the present invention in practical use may be modified into another structure and the like without departing from the spirit and scope of the present invention.

[Advantage of Embodiment]

As described above, the information number recognition section 333 of the drive control section 330 counts the information number of subcodes n1 and n2 recorded in the different positions S1 and S2 in the radial direction of the optical disc 10 and the distance recognition section 320 recognizes the distances r1 and r2 between the positions S1, S2 and the center Q of the optical disc 10. After that, the specific linear velocity L of the optical disc 10 is calculated based on the information numbers n1 and n2, distances r1 and r2, and the type of the optical disc 10. A predetermined position at which information processing is performed based on a request for information processing is recognized using contents information and the like, the distance between the actual predetermined position and the center Q is calculated based on the calculated linear velocity L, and the drive of the moving section 230 is then controlled to move the optical pickup 220 to the predetermined position at which information processing is performed. As a result, at the time when information processing is performed, the optical pickup 220 can be moved to an adequate position with simple calculations based on the specific linear velocity of the optical disc 10. For example, at the time when the presence/absence, type, or the like of the optical disc 10 is determined, the processing for recognizing the specific linear velocity of the optical disc 10 need not be separately performed but can be performed in parallel with the other processing, thereby reducing the time to start information processing. As a result, speedy information processing can be achieved.

The information number recognition section 333 of the drive control section 330 counts the information number of subcodes n1 and n2 recorded in the different positions S1 and S2 in the radial direction of the optical disc 10 rotated at a predetermined rotation speed and the distance recognition section 320 recognizes the distances r1 and r2 between the positions S1, S2 and the center Q of the optical disc 10. After that, the specific linear velocity L of the optical disc 10 is calculated based on the information numbers n1 and n2, distances r1 and r2, and the type of the optical disc 10. A predetermined position at which information processing is performed based on a request for information processing is calculated with relative ratio based on the calculated linear velocity L, and the drive of the moving section 230 is then controlled to move the optical pickup 220 to the predetermined position at which information processing is performed. As a result, at the time when information processing is performed, the optical pickup 220 can be moved to an adequate position with simple calculations based on the specific linear velocity of the optical disc 10. For example, at the time when the presence/absence, type, or the like of the optical disc 10 is determined, the processing for recognizing the specific linear velocity L of the optical disc 10 need not be separately performed but can be performed in parallel with the other processing, thereby reducing the time to start information processing. As a result, speedy information processing can be achieved.

The priority application Number JP2004-099475 upon which this patent application is based is hereby incorporated by reference.

1. An information processing device that allows a drive section to rotate a disc recording medium and allows an information processing section which is moved, by a moving section, along the recording surface of the disc recording medium in the radial direction thereof to perform at least one of a process of reading information recorded on the disc recording medium and a process of recording the information onto the disc recording medium, comprising:
a drive control section that controls the rotation of the drive section to allow the information processing section to read at least one of the number of frames and the number of preformat information recorded at a plurality of positions different in the radial direction of the disc recording medium;
a distance recognition section that recognizes the moving status of the information processing section and thereby recognizes the distances between the respective positions at which the information processing section reads the information and the center of the disc recording medium; and
a movement distance control section that recognizes a predetermined position of the information to be processed on the disc recoding medium in response to a request for information processing, recognizes the distance between the predetermined position on the disc recording medium and the center thereof based on the number of the information that has been read at the different positions, the recognized respective distances, and the type of the disc recording medium, and controls, based on the recognized distance, the moving section to move the information processing section to the predetermined position.

2. The information processing device according to claim 1, wherein
the movement distance control section calculates the linear velocity of the disc recording medium based on the number of the information that has been read at the different positions, recognized respective distances, and the type of the disc recording medium, and, based on the linear velocity, recognizes the distance between the distance between the predetermined position on the disc recording medium and the center thereof.

3. An information processing device that allows a drive section to rotate a disc recording medium and allows an information processing section which is moved, by a moving section, along the recording surface of the disc recording medium in the radial direction thereof to perform at least one of a process of reading information recorded on the disc recording medium and a process of recording the information onto the disc recording medium, comprising:
a drive control section that controls the rotation of the drive section to allow the information processing section to read at least one of the number of frames and the number of preformat information recorded at a plurality of positions different in the radial direction of the disc recording medium;
a distance recognition section that recognizes the moving status of the information processing section and thereby recognizes the distances between the respective positions at which the information processing section reads the information and the center of the disc recording medium; and
a movement distance control section that calculates the linear velocity of the disc recording medium based on the number of the information that has been read at the different positions, the recognized respective distances, and the type of the disc recording medium, calculates the distance between a predetermined position of the information to be processed on the disc recoding medium and the center thereof based on the linear velocity, and controls, based on the calculated distance, the moving section to move the information processing section to the predetermined position.

4. The information processing device according to claim 2, wherein
the movement distance control section calculates the linear velocity of the disc recording medium based on the following relational expression:
L=((r1×r1−r2×r2)×π)/(K(n1−n2))
where L is the linear velocity, r1 is the distance up to a first position at which the information processing section reads the information, n1 is the number of information read at the first position, r2 is the distance up to a second position at which the information processing section reads the information, n2 is the number of information read at the second position, and K is the variable corresponding to type of the disc recording medium.

5. The information processing device according to claim 3, wherein
the movement distance control section calculates the linear velocity of the disc recording medium based on the following relational expression:
L=((r1×r1−r2×r2)×π)/(K(n1−n2))
where L is the linear velocity, r1 is the distance up to a first position at which the information processing section reads the information, n1 is the number of information read at the first position, r2 is the distance up to a second position at which the information processing section reads the information, n2 is the number of information read at the second position, and K is the variable corresponding to type of the disc recording medium.

6. The information processing device according to claim 4, wherein
the movement distance control section calculates the distance r2, by which the information processing section is moved to the predetermined position, based on the following relational expression:
r2=(−(L×K×(n1−n2)/π)+(r1×r1))^{1/2}.

7. The information processing device according to claim 5, wherein
the movement distance control section calculates the distance r2, by which the information processing section is moved to the predetermined position, based on the following relational expression:
r2=(−(L×K×(n1−n2)/π)+(r1×r1))^{1/2}.

8. The information processing device according to claim 4, wherein
the variable K is calculated based on the following relational expression:
K=Tp/V
where Tp is the number of track pitches of the disc recording medium, and V is the coefficient corresponding to the type of the disc recording medium.

9. The information processing device according to claim 5, wherein
the variable K is calculated based on the following relational expression:
K=Tp/V
where Tp is the number of track pitches of the disc recording medium, and V is the coefficient corresponding to the type of the disc recording medium.

10. The information processing device according to claim 1, wherein
the moving section includes a stepping motor for moving the information processing section, and
the distance recognition section includes an internal counter which counts in accordance with the movement distance from a reference position of the information processing section and a distance calculation section which calculates, based on the count value of the internal counter, the distance between the center of the disc recording medium and the position on the disc recording medium at which the information processing section performs information processing.

11. The information processing device according to claim 3, wherein
the moving section includes a stepping motor for moving the information processing section, and
the distance recognition section includes an internal counter which counts in accordance with the movement distance from a reference position of the information processing section and a distance calculation section which calculates, based on the count value of the internal counter, the distance between the center of the disc recording medium and the position on the disc recording medium at which the information processing section performs information processing.

12. The information processing device according to claim 1, wherein
the drive control section includes a type recognition section that recognizes the type of the disc recording medium.

13. The information processing device according to claim 3, wherein
the drive control section includes a type recognition section that recognizes the type of the disc recording medium.

14. The information processing device according to claim 12, wherein
the information processing section is an optical pickup, and
the type recognition section recognizes the type of the disc recording medium based on the state of the light emitted to the disc recording medium and reflected therefrom.

15. The information processing device according to claim 13, wherein
the information processing section is an optical pickup, and
the type recognition section recognizes the type of the disc recording medium based on the state of the light emitted to the disc recording medium and reflected therefrom.

16. The information processing device according to claim 1, wherein
the movement distance control section calculates, based on the calculated linear velocity of the disc recording medium, the position of the predetermined information from the position of the predetermined information recorded based on information described in a lead-in area of the disc recording medium.

17. The information processing device according to claim 3, wherein
the movement distance control section calculates, based on the calculated linear velocity of the disc recording medium, the position of the predetermined information from the position of the predetermined information recorded based on information described in a lead-in area of the disc recording medium.

18. A disc unit comprising:
a drive section that rotates a disc recording medium;
an information processing section that performs at least one of a process of reading information recorded on the disc recording medium and a process of recording the information onto the disc recording medium;
a moving section that moves the information processing section along the recording surface of the disc recording medium in the radial direction thereof;
a drive control section that controls the rotation of the drive section to allow the information processing section to read at least one of the number of frames and the number of preformat information recorded at a plurality of positions different in the radial direction of the disc recording medium;
a distance recognition section that recognizes the moving status of the information processing section and thereby recognizes the distances between the respective positions at which the information processing section reads the information and the center of the disc recording medium; and
a movement distance control section that recognizes a predetermined position of the information to be processed on the disc recoding medium in response to a request for information processing, recognizes the distance between the predetermined position on the disc recording medium and the center thereof based on the number of the information that has been read at the different positions, the recognized respective distances, and the type of the disc recording medium, and controls, based on the recognized distance, the moving section to move the information processing section to the predetermined position.

19. A disc unit comprising:
a drive section that rotates a disc recording medium;
an information processing section that performs at least one of a process of reading information recorded on the disc recording medium and a process of recording the information onto the disc recording medium;
a moving section that moves the information processing section along the recording surface of the disc recording medium in the radial direction thereof, a drive control section that controls the rotation of the drive section to allow the information processing section to read at least one of the number of frames and the number of preformat information recorded at a plurality of positions different in the radial direction of the disc recording medium;
a distance recognition section that recognizes the moving status of the information processing section and thereby recognizes the distances between the respective positions at which the information processing section reads the information and the center of the disc recording medium; and
a movement distance control section that calculates the linear velocity of the disc recording medium based on the number of the information that has been read at the different positions, the recognized respective distances, and the type of the disc recording medium, calculates the distance between a predetermined position of the information to be processed on the disc recoding medium and the center thereof based on the linear velocity, and controls, based on the calculated distance, the moving section to move the information processing section to the predetermined position.

20. A disc unit comprising:
an information processing section that performs at least one of a process of reading information recorded on a disc recording medium and a process of recording the information onto the disc recording medium;
a moving section that moves the information processing section along the recording surface of the disc recording medium in the radial direction thereof;
a controller that calculates the distance between a predetermined position of the information to be processed on the disc recording medium and the center of the disc recording medium based on at least one of the number of frames and the number of preformat information recorded at different positions on the disc recording medium in the radial direction and read by the information processing section, the distances up to the respective positions at which the information processing sections reads the information, and the type of the disc recording medium to allow the moving section to move the information processing section.

21. An information processing method that rotates a disc recording medium and moves the information processing section along the recording surface of the disc recording medium in the radial direction thereof to thereby perform at least one of a process of reading information recorded on the disc recording medium and a process of recording the information onto the disc recording medium, comprising the steps of:
counting at least one of the number of frames and the number of preformat information recorded at different positions on the disc recording medium in the radial direction and recognizing the distance between the respective positions and the center of the disc recording medium;
recognizing a predetermined position of the information to be processed on the disc recoding medium in response to a request for information processing to thereby recognize the distance between the predetermined position on the disc recording medium and the center thereof based on the number of the information that has been read at the different positions, the recognized respective distances, and the type of the disc recording medium; and
controlling the moving section based on the recognized distance to move the information processing section to the predetermined position.

22. An information processing method that rotates a disc recording medium and moves the information processing section along the recording surface of the disc recording medium in the radial direction thereof to thereby perform at least one of a process of reading information recorded on the disc recording medium and a process of recording the information onto the disc recording medium, comprising the steps of:
counting at least one of the number of frames and the number of preform at information recorded at different positions on the disc recording medium in the radial direction and recognizing the distance between the respective positions and the center of the disc recording medium;
calculating the linear velocity of the disc recording medium based on the number of the information that has been read at the different positions, the recognized respective distances, and the type of the disc recording medium;
calculating the distance between a predetermined position of the information to be processed on the disc recoding medium and the center thereof based on the calculated linear velocity; and
controlling the moving section based on the calculated distance to move the information processing section to the predetermined position.

23. A recording medium on which an information processing program is recorded in a readable manner by a calculation section, the information processing program allowing the calculation section to function as an information processing device that allows a drive section to rotate a disc recording medium and that allows an information processing section which is moved, by a moving section, along the recording surface of the disc recording medium in the radial direction thereof to perform at least one of a process of reading information recorded on the disc recording medium and a process of recording the information onto the disc recording medium, wherein
the information processing device includes functions as:
a drive control section that controls the rotation of the drive section to allow the information processing section to read at least one of the number of frames and the number of preformat information recorded at a plurality of positions different in the radial direction of the disc recording medium;
a distance recognition section that recognizes the moving status of the information processing section and thereby recognizes the distances between the respective positions at which the information processing section reads the information and the center of the disc recording medium; and
a movement distance control section that recognizes a predetermined position of the information to be processed on the disc recoding medium in response to a request for information processing, recognizes the distance between the predetermined position on the disc recording medium and the center thereof based on the number of the information that has been read at the different positions, the recognized respective distances, and the type of the disc recording medium, and controls, based on the recognized distance, the moving section to move the information processing section to the predetermined position.

24. A recording medium on which an information processing program is recorded in a readable manner by a calculation section, the information processing program allowing the calculation section to function as an information processing device that allows a drive section to rotate a disc recording medium and that allows an information processing section which is moved, by a moving section, along the recording surface of the disc recording medium in the radial direction thereof to perform at least one of a process of reading information recorded on the disc recording medium and a process of recording the information onto the disc recording medium, wherein
the information processing device includes functions as:
a drive control section that controls the rotation of the drive section to allow the information processing section to read at least one of the number of frames and number of preformat information recorded at a plurality of positions different in the radial direction of the disc recording medium;
a distance recognition section that recognizes the moving status of the information processing section is moved by the moving section and thereby recognizes the distances between the respective positions at which the information processing section reads the information and the center of the disc recording medium; and
a movement distance control section that calculates the linear velocity of the disc recording medium based on the number of the information that has been read at the different positions, the recognized respective distances, and the type of the disc recording medium, calculates the distance between a predetermined position of the information to be processed on the disc recoding medium and the center thereof based on the linear velocity, and controls, based on the calculated distance, the moving section to move the information processing section to the predetermined position.
